(19) United States
(12) Patent Application Publication
(10) Pub. No.: US 2009/0238364 A1
(43) Pub. Date: Sep. 24, 2009

(54) IMAGE SCANNER

(76) Inventors: Akihiro Furukawa, Nagoya (JP); Satoko Ando, Chita (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 12/365,764

(22) Filed: Feb. 4, 2009

(30) Foreign Application Priority Data
Feb. 4, 2008 (JP) 2008023633

(51) Int. Cl. H04N 1/44; H04N 1/04; G06F 21/00

(52) U.S. Cl. 380/243; 358/474; 726/4

(57) ABSTRACT

A scanner includes a scanning unit which scans an object to generate scan data, a scan data storage, a location information transmitting unit configured to transmit location information indicative of a location where the scan data is stored to an external device, a device-location storage stores device-location information including device identifying information used for identifying a device to which the scan data generated by the scanning unit is transmitted and the location identifying information in a associated manner, a reception unit receives combination information representing a combination of the device identifying information and the location identifying information, and a scan data transmitting unit configured to transmit the scan data stored at a location identified by the location identifying information to the device identified by the device identifying information on condition that the combination represented by the combination information received by the reception unit is stored in the device-location storage.

### CROSS-REFERENCE TO RELATED APPLICATION

This application claims priority under 35 U.S.C. §119 from Japanese Patent Application No. 2008-023633 filed on Feb. 4, 2008. The entire subject matter of the application is incorporated herein by reference.

### BACKGROUND

1. Technical Field

The present invention relates to an image scanner capable of transmitting scan data to external devices and computer-accessible recording medium containing program for the image scanner.

2. Prior Art

Image scanners having a function of transmitting scan data to external devices have been known. An example of such an image scanner is disclosed in Japanese Patent Provisional Publication No. 2006-311344 (hereinafter, referred to as '344 publication). An image scanner disclosed in '344 publication is configured to scan an image to generate scan data and store the generated scan data in a predetermined storage, which is connected to a network. Further, the image scanner is capable of creating an e-mail message, in which a URL (Uniform Resource Locator) of the predetermined storage is indicated, and transmitting the same to external devices. Then, a user of each of the external devices can access the predetermined storage based on the URL indicated in the e-mail message to download the scan data.

### SUMMARY OF THE INVENTION

As described above, the image scanner disclosed in '344 publication is capable of transmitting location identifying information (e.g., the URL in the above example) which indicates a location, where the scan data is stored, to external devices.

According to such a configuration, there is a possibility that the location identifying information might be sneaked out by a third person when the location identifying information is transmitted from the image scanner to the external devices. Once the location identifying information is sneaked out, the scan data itself might be sneaked out easily.

The present invention, which has been made in consideration of the above problem, is advantageous in that there is provided a scanner, which includes a scanning unit configured to scan an object to generate scan data, a scan data storage configured to store the scan data generated by the scanning unit, a location information transmitting unit configured to transmit location identifying information indicative of a location where the scan data is stored to an external device, a device-location storage configured to store device-location information including device identifying information used for identifying a device with which the scan data generated by the scanning unit is transmitted and the location identifying information in a associated manner, a reception unit configured to receive combination information representing a combination of the device identifying information and the location identifying information, and a scan data transmitting unit configured to transmit the scan data stored at a location identified by the location identifying information to the device identified by the device identifying information on condition that the combination represented by the combination information received by the reception unit is stored in the device-location storage.

The external device to which the scan data is transmitted may be determined by the user per every scanning operation. Alternatively, the scan data may be transmitted to a predetermined device. Further alternatively, the device may be determined according to other methods. Examples of such a device may include a personal computer, a server, a printer, a mobile terminal (a cell phone, a PDA (personal digital assistant)) and the like. The location identifying information should be interpreted in the broadest manner and may include any information that is used for identifying the location where the scan data is stored. Examples of the location information may include a URI (Uniform Resource Identifiers), a URL, a folder name, a file name and the like.

Further, the device identifying information should be interpreted in the broadest manner and may include any information used for identifying a device. Examples of the device identifying information may be the URI, URL, IP address, MAC address and the like.

The act of “receiving a combination” needs not be limited to receive each components of the combination simultaneously. Rather, one or more components of the combination may be received at different timings.

According to another aspects of the invention, there is provided a computer-readable recording medium containing computer-executable instructions which cause a computer implemented in a scanner to execute the steps of scanning an object to generate scan data, storing the scan data generated in the step of scanning, transmitting location identifying information indicative of a location where the scan data is stored to an external device, storing device-location information including device identifying information used for identifying a device to which the scan data generated by the scanning unit is transmitted and the location identifying information in an associated manner, receiving combination information representing a combination of device identifying information and the location identifying information, and transmitting the scan data stored at a location identified by the location identifying information to the device identified by the device identifying information on condition that the combination represented by the combination information received in the step of receiving is stored in the step of storing device-location information.

### BRIEF DESCRIPTION OF THE ACCOMPANYING DRAWINGS

FIG. 1 is a block diagram showing a configuration of an image scanner system according to an embodiment of the invention.

FIG. 2 schematically shows contents stored in URL storing area.

FIG. 3 schematically shows a configuration of a scan data storing area.

FIG. 4 schematically shows a configuration of a corresponding information storing area.

FIGS. 5-8 show a flowchart illustrating a “SCAN-TO” process according to the embodiment of the invention.

FIGS. 9 and 10 show a flowchart illustrating a “SCAN DATA PROVIDING” process according to the embodiment of the invention.

FIG. 11 shows a flowchart illustrating a “CANCELLATION” process according to the embodiment of the invention.

### DETAILED DESCRIPTION OF THE EMBODIMENT

Referring now to the accompanying drawings, a description will be given in detail of an image scanning system according to a preferred embodiment of the invention.

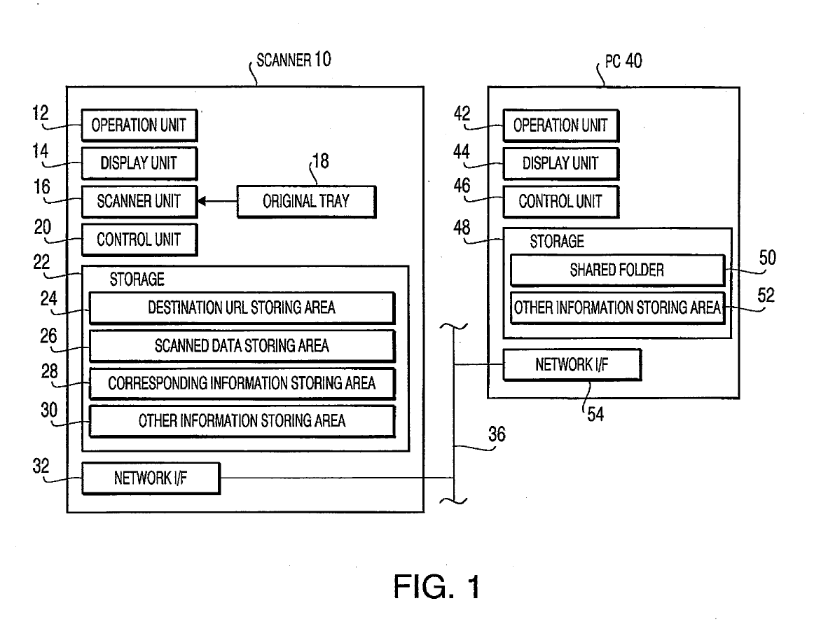

FIG. 1 is a block diagram showing a configuration of an image scanning system 2 according to the embodiment. The image scanning system 2 includes an image scanner 10 and a PC (Personal Computer) 40. It should be noted that, although only one PC 40 is shown in FIG. 1, the image scanning system 2 could include more than one PC 40. The image scanner 10 and one or more PC's 40 are interconnected through communication lines 36 such as communication lines of a LAN (Local Area Network), the Internet or the like so that the devices (i.e., the image scanner 10 and one or more PCs 40) can be communicate with each other.

<Configuration of Image Scanner>

The image scanner 10 includes an operation unit 12, a display unit 14, a scan unit 16, an original tray 18, a control unit 20, a storage unit 22 and a network interface 32.

The operation unit 12 has a plurality of keys to be operated by a user. By operating the operation unit 12, the user can input various pieces of information and commands in the image scanner 10. The display unit 14 is configured to display various pieces of information. The scan unit 16 scans the original placed on the original tray 18 to generate scan data. The control unit 20 executes various processes in accordance with programs stored in the storage unit 22. The processes executed by the control unit 20 will be described in detail later.

The storage unit 22 includes a ROM (Read Only Memory), an EEPROM (Electronically Erasable ROM), a RAM (Random Access Memory) and the like. The storage unit 22 is provided with a URL storing area 24, a scan data storing area 26, a corresponding information storing area 28 and a non-classified storing area 30. Information stored in each of the storing areas 24, 26 and 28 will be described hereinafter.

<URL Storing Area 24>

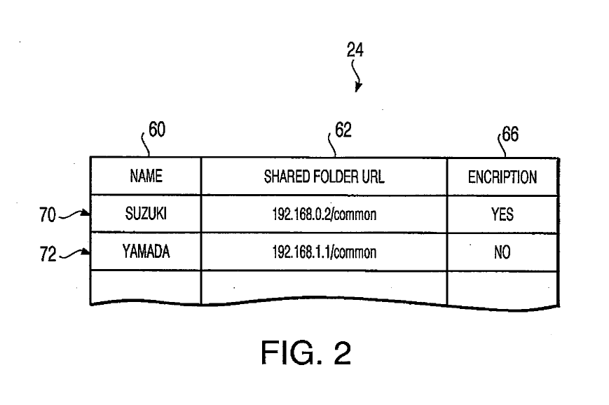

The URL storing area 24 stores information indicating devices to which the scan data is to be transmitted. FIG. 2 schematically shows a configuration of the URL storing area 24. The URL storing area 24 is configured to store a plurality of sets of data 70, 72, . . . as shown in FIG. 2. Each of the sets of data 70, 72, . . . includes, as shown in FIG. 2, a name 60, a URL of a shared folder 62 and encryption information 66, which are associated with each other. The URL of the shared folder 62 represents a URL of a shared folder set to the PC 40. It should be noted that, in the specification, the term “shared folder” means a folder which can be accessed from external devices. That is, if a device has a “shared folder,” files stored in the shared folder can be accessed from outside and/or new files can be stored by external devices.

According to the embodiment, the URL of the shared folder includes an IP address of the device (PC 40) in which the shared folder is defined. For example, a shared folder URL 62 of the set of data 70 is <192.168.0.2/common>, which includes an IP address <192.168.0.2>. It should be noted that, in the description, a scheme character string (e.g., file://) is omitted in FIG. 2 for brevity. Similarly, in the following description, the scheme character string will be omitted occasionally. Encryption flag 66 indicates whether a password, which will be described later, is to be generated.

The user can store each of the sets of data 70, 72 in the URL storing area 24. For example, the sets of data 70, 72 are stored in the URL storing area 24 when the user operates the operation unit 12. Alternatively or optionally, the user may input each of the sets of data 70, 72 in an external device (i.e., a device other than the scanner 10), and make the external device 10 transmit the sets of data 70, 72 to the scanner 10. In such a case, the scanner 10 stores the data 70, 72, which is received from the external device, in the URL storing area 24.

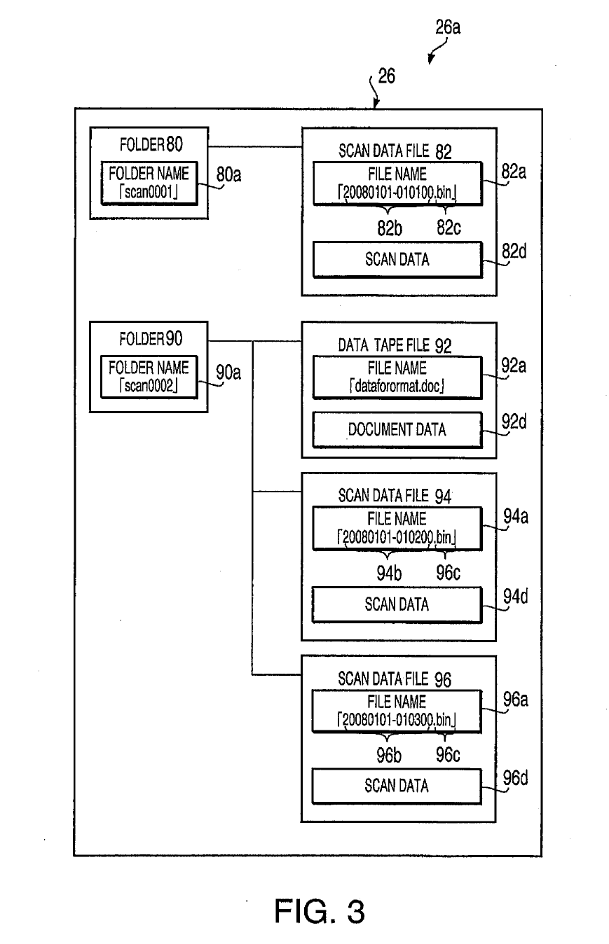

The scan data storage 24 is configured to store the scan data generated by the scanning unit 16. FIG. 3 shows an example of stored contents in the scan data storing area 24. Incidentally, 26a in FIG. 3 denotes a host name of the scanner 10. The scan data storing area 26 is configured to store the scan data (i.e., scan data files) making use of a hierarchical structure of files and folders. The scan data storing area 26 is capable of storing a plurality of scan data files. In the example shown in FIG. 3, there are two folders 80 and 90, which are stored in the scan data storing area 26. The folder 80 has a folder name 80a, “scan0001.” The folder 80 stores a scan data file 82. That is, the scan data file 82 exists in the folder 80. The scan data file 82 has a file name 82a and includes scan data 82d, which are associated with each other. The file name 82a includes a character string 82b, which represents date and time when the scan data file 82 was generated. In the example shown in FIG. 3, the character string 82b shows that the file was generated at 01:01:00 on Jan. 1, 2008. The file name 82a includes a character string 82c representing an extension. According to the embodiment, the extension “.bin” is used. Generation of the folder 80 and scan data 82 will be described in detail later.

In this embodiment, the folder 90 has a folder name 90a, “scan0002.” The folder 90 contains three files 92, 94 and 96. Specifically, the folder 90 stores one data type file 92 and a plurality of scan data files 94 and 96. The data type file 92 has a file name 92a and document data 92d which are associated with each other. The document data 92d is data describing the data type of the scan data. Concrete contents of the document data will be described in detail later. Similar to the scan data file 82 described above, the scan data file 94 has a file name 94a and scan data 94d, which are associated with each other. The file name 94a includes a character string 94b representing date and time when the scan data file 94 was generated, and a character string 94c that represents the extension. The scan data file 96 has a file name 96a and scan data 96b, which are associated with each other. The file name 96a includes a character string 92b representing the date and time when the scan data file 96 was generated, and another character string 96c representing the extension of the file. Generation of the folders 90, files 92, 94 and 96 will be described in detail later.

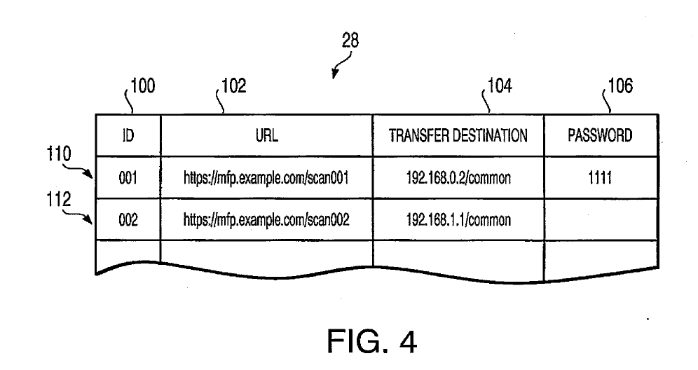

FIG. 4 shows an example of contents stored in the corresponding information storing area 28. The corresponding information storing area 28 is configured to store a plurality of pieces of corresponding information 110, 112, etc. In FIG. 4, each piece of the corresponding information includes an ID 100, URL 102, a transmission destination 104 and a password 106, which are associated with each other. The ID 100 represents information which identifies respective pieces of corresponding information. The URL 102 represents the URL at which the folder containing the scan data is stored. The transmission destination 104 represents the URL of the shared folder and IP address of the device, to which the scan data is transmitted. The password 106 represents the password which is output when the scan data is generated. Incidentally, the corresponding information may not includes a password (see the corresponding information 112 in FIG. 4). Generation of the corresponding information 110, 112, . . . will be described in detail later.

The storing area 30 is configured to store information other than information which is to be stored in the storing areas 24, 26 and 28 described above. The information to be stored in the storing area 30 will be described later when necessary.

The network interface 32 is connected to a communication line 36. The scanner 10 is capable of communicating with the PC 40 via the network interface 32 and the communication line 36.

<Configuration of PC>

The PC 40 includes an operation unit 42, a display unit 44, a control unit 46, a storage 48 and a network interface 54. The operation unit 42 is provided with a keyboard and a mouse. The user can input various kinds of information/commands into the PC 40 by operating the operation unit 42. The display unit 44 is configured to display various types of information. The control unit 46 is configured to executed various processes according to programs stored in the storage 48.

The storage 48 includes a ROM, an EEPROM, a RAM and an HDD. The storage 48 is provided with a shared folder 50 and other information storing area 52. The user can generate the shared folder 50 in the PC 40 by operating the operation unit 42. The shared folder 50 is a folder which can be accessed externally by other devices. In other words, folders which are not defined as shared folders cannot be accessed by other devices. According to the embodiment, the shared folder URL 62 (192.168.0.2/common) included in the set data 70 corresponds to the shared folder 50 of the PC 40. In the storage area 52, various types of information can be stored.

The network interface 54 is connected to the communication line 36. The PC 40 is capable of communicating the scanner 10 via the network interface 54 and the communication line 36.

<Scan-To Process>

Next, processes executed by the scanner 10 will be described. That is, the processes described hereinafter are executed by the control unit 20 of the scanner 10.

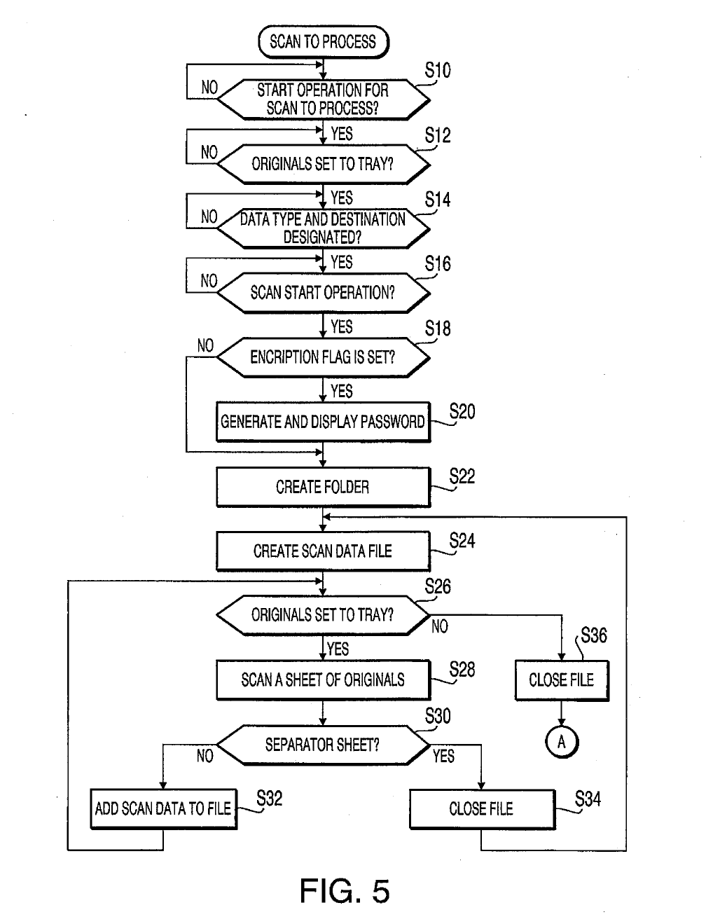

FIGS. 5-8 show a flowchart illustrating a Scan-To process. The user can start the Scan-To process by operation the operation unit 12 of the scanner 10. The control unit 20 monitors operation of the operation unit 12 and judges whether the user instructs start of the Scan-To process (S10). If the control unit 20 determines that the start of the Scan-To process is instructed (S10: YES), the control unit 20 judges whether an original is placed on the original tray 18 (S12). If the original is not placed on the original tray 18 (S12: NO), the control unit 20 pauses until the original is placed on the original tray 18.

If the control unit 20 determines that the original is placed on the original tray 18 (S12: YES), the control unit 20 awaits until the data type of the scan data and the transmission destination (S14). The user can designate the data type of the scan data by operating the operation unit 12. Specifically, the user can designates three items regarding the data type of the scan data.

Firstly, the user can designate a resolution of scan data. The user can designate a single scanning resolution or multiple scanning resolutions. Secondly, the user can designate color information (color, grayscale or black and white) of the scan data. The user can designate only one piece of color information, or a plurality of pieces of color information. Lastly, the user can designate a file type among PDF, TIFF, JPEG and the like. The user can designate only one file type or a plurality of file types. When each of the three items are designated by the user, the control unit 20 store the scan data in accordance with the designated items in the storing area 30.

Further, the user can designate at least one set data from among a plurality of pieces of set data 70, 72, . . . stored in the device URL storing area 24 (see FIG. 2) by operating the operation unit 12. As the set data is designated, the transmission destination of the scan data is designated. The control unit 20 stores the set data (i.e., the information regarding the transmission destination) designated by the user in the storing area 30. When the data type and transmission destination of the scan data are designated, the process proceeds to S16.

The user is capable of start scanning by operating the operation unit 12. In Si 6, the control unit 20 monitors the operation of the operation unit 12 to judge whether the user input a command to start scanning. If the user operates the operation unit 12 to start scanning (S16: YES), the control unit 20 judges whether the encryption flag 66 included in the set data designated in S14 is set to “YES” (S18). In the example shown in FIG. 2, the encryption flag 66 of the set data 70 is “YES.” Therefore, if the set data designated in S14 is the set data 40, the process judges that the encryption flag 66 is set to “YES” in S18, and the process proceeds to S20. Further, in the example shown in FIG. 2, the encryption flag 66 of the set data 72 is “NO.” Therefore, if the set data designated in S14 is the set data 72, the judgment in S18 is “NO” and the process skips S20.

In S20, the control unit 20 generates a password and displays the same. For example, the control unit 20 may select one number among a plurality of numbers and generate a password including the thus selected number. Alternatively, the control unit 20 may increment the number which was generated in S20 as a password to generate a new password. The control unit 20 displays the generated password on the display unit 14. Thus, the user can recognize the newly generated password. It should be noted that the password may be notified to the user in a different way. For example, the newly generated password may be notified by speech output, printing matter or may be transmitted to another device (e.g., a cell phone of the user). The password newly generated in S20 is stored in the storing area 30 by the control unit 20.

Next, the control unit 20 creates a folder in the scan data storing area 26 and a name of the folder (S22). According to the embodiment, the folder name includes a character string “scan” followed by a four-digit number. In S22, the control unit 20 adds 1 (one) to the four-digit number of the folder name previously generated in S22. For example, if the previously generated folder name is “scan0002,” which is the name of the folder 90a in FIG. 3, then the newly generated folder name is “scan0003.” Thereafter, the process proceeds to S24.

In S24, the control unit 20 creates a file in the folder generated in S22 and a name of the file. The file name is used as the file name of the scan data. Specifically, the control unit 20 generates the file name by including a character string representing a current date and time and a character string representing the extension (i.e., “.bin”) as files 82a, 94a and 96a shown in FIG. 3). Incidentally, when the process executes S24, the scan data has not yet been generated.

Next, the control unit 20 judges whether the original is placed on the original tray 18 (S26). If the original is placed on the original tray 18 (S26: YES), the control unit 20 drives the scanning unit 16 to scan a sheet of the original (S28). The control unit 20 determines a method of scanning based on the data type designated in S14. For example, if the data type designated in S14 represents “150 dpi” in resolution, “color” in color information and “PDF” in file format, the control unit 20 executes the color scanning at the resolution of 150 dpi. Further, the control unit 20 generates the scan data file in the PDF file format in S32. It should be noted that, the extension “.bin” is used as the extension of the file name generated in S24. If multiple resolutions and/or multiple pieces of color information and/or multiple files are designated in S114, the control unit 20 generates the scan data which is used as base data for generating scan data of the combinations of all the designated items. That is, the control unit 20 generates scan data which can be converted into any one of the combinations. For example, if the user designates multiple resolutions, the number of which is L, multiple pieces of color information, the number of which is M and multiple file types, the number of which is N, the control unit 20 generates basic scan data which can be used to generate all the L×M×N combinations of scan data. If multiple pieces of color information are designated, the control unit 20 generates the scan data according to the highest number of colors. If the user designates the “color,” “grayscale” and “black and white,” the control unit 20 executes the color scanning. If the user designates multiple file types, the control unit 20 generates a scan data file having a file type which can be converted to any one of the designated file types.

The user can insert a separator sheet among a plurality of sheets of the original subjected to scanning. The separator sheet can be of any type if it can be distinguished from the sheet to be scanned. According to the embodiment, a black sheet of which the entire surface is black is used as the separator sheet. In S30, the control unit 20 judges whether a sheet subjected to scanning (hereinafter, referred to a target sheet) is the separator sheet or not based on the scan data obtained in S28. If the target sheet is not the separator sheet (S30: NO), the control unit 20 stores the scan data obtained in S28 in the scan data storing area 26 (S32). The control unit 20 makes the scan data with the file name created in S24. After execution of S32, the control unit 20 returns to S26, and judges whether there is a next sheet to be scanned. If there is next sheet to be scanned (S26: YES), the control unit 20 scans the next sheet (S28). If the sheet is not the separator sheet (S30: NO), the control unit 20 stores the scan data obtained in S28 in the scan data storing area 26 (S32). At this time, the scan data is stored subsequent to the scan data which was stored in previous execution of S32. Thus, according to the embodiment, a single scan data file can include scan data of a plurality of sheets of the original.

In S30, if the control unit 20 judges that the target sheet is the separator sheet (S30: YES), the control unit 20 close the scan data file generated in S24 (S34). In this case, the control unit 20 returns to S24 and creates an new file under the folder created in S22. That is, if the process executes S24 after execution of S34, a plurality of scan data files are generated under a single folder. For example, in the example shown in FIG. 3, the folder 90 includes a plurality of scan data files 94 and 96. This means that the process executed S24 after execution of S34. In other words, if S24 is not executed after execution of S24, only a single scan data file exists under the folder. For example, in the example shown in FIG. 3, the folder 80 contains only one scan data file 82. This means, S24 has not been executed after S34 was executed.

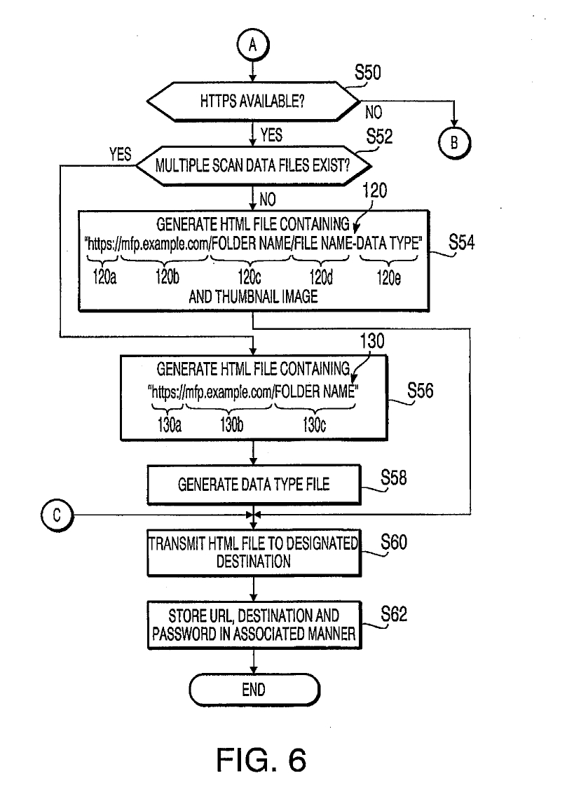

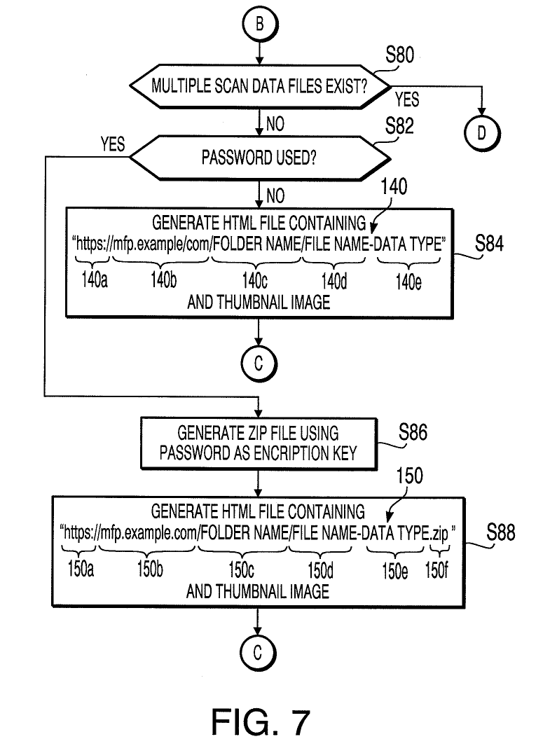

When all the sheets of the original placed on the original tray 18 have been scanned, the judgment of the control unit 20 at S26 is “NO.” In such a case, the control unit 20 closes the scan data file created in S24 (S36). Then, the process proceeds to S50 (see FIG. 6). In S50, the process judges whether HTTPS can be used. When the user intends to use the HTTPS, the user registers the setting therefor with the scanner 10 in advance. In this case, the judgment of the control unit 20 in S50 is “NO.” In this case, the process proceeds to S80 of FIG. 7.

In S52, the control unit 20 judges whether multiple scan data files are stored in the folder generated in S22 of FIG. 5. For example, if the folder 80 of FIG. 3 is the folder generated in S22 of FIG. 5, the judgment of the control unit 20 in S52 is “NO.” It is because the folder 80 contains only one scan data file 82. If the judgment in S52 is “NO,” the control unit 20 generates an HTML file including the URL and thumbnail images (S54). In the flowchart shown in FIG. 6, an example of the URL 120 generated in S54 is indicated. The URL 120 includes a scheme character strings 120a representing the communication protocol of the HTTPS, a host name 120b of the scanner 10, the folder name 120c generated in S22 of FIG. 5, the file name 120d generated in S24 and the data type character string 120e representing the data type. The data type character string 120d is a character string identifying the data type designated by the user in S14 of FIG. 5. For example, if the data type designated in S14 of FIG. 5 implies that the resolution is “150 dpi,” the color information is “color,” and the file type is “PDF,” the control unit 20 generates the data type character string 120e, “c150.pdf.”

As described above, in S14 of FIG. 5, the user can designate multiple resolutions, multiple pieces of color information and/or multiple file formats. In such a case, the control unit 20 generates the URL 120 including the character string 120e identifying the data type for each of the combinations of the designated items (i.e., resolutions, color information and file formats). For example, if the number of designated resolutions is L, the number of designated pieces of color information is M and the number of designated file formats is N, the control unit 20 generates L×M×N URL's 120. For example, in the data type designated in S14, if the resolutions are “150 dpi” and “300 dpi,” the color information is “color” and “grayscale,” and the file format is “PDF,” the control unit 20 generates a URL including “c150.pdf,” a URL including “c300.pdf,” “g150.pdf” and “g300.pdf.” In these URL's, the other parts (i.e., 120a-120d) of the character string are the same.

The control unit 20 generates a thumbnail image based on the scan data for the first page included in the scan data file generated in S24 of FIG. 5. The thumbnail image is image data having a resolution which is lower than the resolution of the scan data. The control unit 20 generates the thumbnail image reflecting the data type (i.e., data type representing character string 120e) included in the URL 120. For example, the control unit 20 varies the size of the thumbnail image depending on the resolution value included in the data type representing character string 120e. Further, the control unit 20 determines the color of the thumbnail image depending on the color information (color, grayscale or black and white) included in the data type representing character string 120e. Incidentally, as described above, multiple URL's 120 may be generated. In such a case, the control unit 20 generates a thumbnail image reflecting the data type representing character string 120e of the corresponding URL 120 for each of the multiple URL's 120. That is, the control unit 20 generates multiple thumbnail images. Then, the control unit 20 generates an HTML file containing the URL(s) 120 generated as above, and the thumbnail image(s). As described above, the HTML file may include multiple URL's 120 and multiple thumbnail images. The control unit 20 stores the HTML file in the storing area 30. As is well known in the art, the HTML file does not contain the thumbnail images but URL's linked to the thumbnail images. In the specification, although the HTML file is configured as above, it is described that the HTML file contains the thumbnail images for brevity. After execution of S54, the process proceeds to S60.

For example, when the folder generated in S22 of FIG. 5 is the folder 90 in FIG. 3, the judgment by the control unit 20 as S52 is “YES.” It is because the folder 90 contains multiple scan data files 94 and 96. When the judgment in S52 is “YES,”, the control unit 20 generates an HTML file which contains the URL's but not thumbnail images (S56). In FIG. 6, an example of the URL 130 generated in S56 is shown. The URL 130 includes the scheme character string 130a indicating the communication protocol of HTTPS, the host name 130b of the scanner 10 and the folder name 130c generated in S22 of FIG. 5. The URL 130 generated in S56 does not include the file name or data type representing character string, different from the URL 120 generated in S54. The control unit 20 generates the HTML file including the URL 130 as generated above. Then, the control unit 20 stores the thus generated HTML file in the storing area 30. After execution of S56, the process proceeds to S58.

In S58, the control unit 20 generates the data type file. The data type file is generated under the folder which is generated in S22 of FIG. 5. In FIG. 3, an example of the data type file is shown, which is denoted by 92. The control unit 20, then generates a file name “dataformat.doc” (see reference number 92a in FIG. 3). Further, the control unit 20 generates document data describing the data type designated in S14 of FIG. 5 (see 92d in FIG. 3). If only one set of data type was designated in S14 of FIG. 5, the document data includes a character string indicating the data type as designated. On the other hand, if multiple sets of data types were designated in S14, the document data includes multiple character strings respectively indicating the multiple data types. Usage of the data type file(s) will be described in detail later. After execution of S58, the process proceeds to S60.

In S60, the control unit 20 transmits the HTML file generated in S54 or S56, which is transmitted to the transmission destination designated in S14 of FIG. 5. As described above, the shared folder URL 62 “192.168.0.2/common” included in the set data 70 shown in FIG. 2 corresponds to the shared folder 50 of the PC 40. Therefore, when the set data 70 is designated in S14 of FIG. 5, the control unit 20 transmits the HTML file generated in S54 or S56, and a command instructing that the HTML file is stored in the shared folder 50 to the PC 40 (i.e., the device of which IP address is “192.168.0.2”). With this process, the HTML file is stored in the shared folder 50 of the PC 40. As a result, the user of the PC 40 can now browse the HTML file stored in the shared folder 50. If the HTML file is one generated in S54, the user can view the URL 120 and the thumbnail image. If the HTML file is one generated in S56, the user can view the RUL 130.

Next, the control unit 20 updates the stored contents of the corresponding information storing area 28 (S62). Specifically, the control unit stores one piece of the corresponding information in the corresponding information storing area 28. That is, the control unit 20 stores corresponding information contains the ID 100, the URL 102 including the folder name generated in S22 of FIG. 5, the transmission destination designated in S14 of FIG. 5 (i.e., the IP address of the transmission destination to which the HTML file is transmitted), and password 106 which are associated with each other in the corresponding information storing area 28. Incidentally, the control unit 20 generates the ID 100 by incrementing the ID 100 processed in previous execution of S62 by one (1). As described above, if the judgment in S18 of FIG. 5 is “NO,” no password is stored in S62. After execution of S62, the Scan-To process is finished.

Next, the process when the judgment in S50 of FIG. 6 is “NO” will be described. When the judgment in S50 is “NO,” the HTTPS cannot be used, and therefore, the HTTP is used. When the judgment in S50 is “NO,” the process proceeds to S80 of FIG. 7. In S80, the control unit 20 judges whether the multiple scan data files are stored in the folder that is generated in S22 of FIG. 5. This step is similar to S52 of FIG. 6. For example, if the folder generated in S22 of FIG. 5 is the folder 80 shown in FIG. 3, the judgment of the control unit in S80 is “NO.” In this case, the control unit 20 judges whether the password is generated in S20 of FIG. 5 (S82). If the judgment in S18 is “NO,” S20 of FIG. 5 is skipped and thus the password is not generated. In such a case, the judgment in S82 is “NO,” and the process proceeds to S84. If the judgment in S18 of FIG. 5 is “YES,” S20 of FIG. 5 is executed and the password is generated. Then, the judgment in S82 is “YES” and the process proceeds to S86.

In S84, the control unit 20 generates the HTML file containing the URL and thumbnail image. In the flowchart shown in FIG. 7, an example of the URL 140 generated in S84 is shown. In this example, the URL 140 includes the scheme character string 140a indicating the communication protocol of HTTP, the host name 140b of the scanner 10, the folder name 140c generated in S22 of FIG. 5, the file name 140d generated in S24 of FIG. 5 and the data type representing character string 140e representing the data type. The data type representing character string 140e is a character string identifying the data type designated by the user in S14 of FIG. 5, and is generated in a manner similar to that generated in S54 of FIG. 6. The control unit 20 stores the HTML file in the storing area 30. After execution of S84, the process proceeds to S60 of FIG. 6. That is, the control unit 20 transmits the HTML file generated in S84 to the transmission destination designated in S14 of FIG. 5. Further, the control unit 20 updates the contents of the corresponding information storing area 28 (S62).

In S86, the control unit 20 generates a zip file based on the scan data file that was generated in S24 of FIG. 5. When the zip file is generated, the control unit 20 uses the password generated in S20 of FIG. 5 as an encryption key. For example, if one data type was designated in S14, the control unit 20 converts the scan data file generated in S24 into the zip file. If multiple data types were designated in S14, the control unit generates multiple zip files corresponding to the designated multiple data types. For example, if the data types designated in S14 includes resolutions of “150 dpi” and “300 dpi,” color information of “color” and “grayscale,” and file format of “PDF,” the control unit 20 converts the scan data included in scan data file generated in S24 of FIG. 5 to generates a (color, 150 dpi) PDF file, a (color, 300 dpi) PDF file, a (grayscale, 150 dpi) PDF file and a (grayscale, 300 dpi) PDF file. Then, the control unit 20 generates the ZIP files from the thus generated PDF files, respectively. Thus, in the above example, four PDF files are generated. The name of the ZIP files includes a character string (e.g., “.pdf.zip”) indicating that they are ZIP files of the files having the file formats designated in S14. The control unit 20 stores the ZIP files generated in S86 under the folder generated in S22 of FIG. 5.

Next, the control unit 20 generates the HTML file including the URL and the thumbnail image (S88). In the flowchart shown in FIG. 7, an example of the URL 150 generated in S88 is indicated. The URL 150 includes the scheme character string 150a indicating the HTTP communication protocol, the host file name 150d of the scanner, the folder name 150c generated in S22 of FIG. 5, the file name 150d generated in S24 of FIG. 5 and the data type representing character string 150e. The data type representing character string 150e is a character string representing the data type designated by the user in S14 of FIG. 5, and is generated in a manner similar to that generated in S54 of FIG. 6. It should be noted that, the data type representing character string 150e also includes the character string 150f representing the extension of the ZIP file, different from a case in S64. Further, the control unit 20 generates the thumbnail image in a manner similar to that generated in S54 of FIG. 6. Then, the control unit 20 stores the HTML file in the storing area 30. After execution of S88, the process proceeds to S60 of FIG. 6. That is, the control unit 20 transmits the HTML file generated in S88 to the transmission destination designated in S14 of FIG. 5. Further, the control unit 20 updates the contents of the corresponding information storing area 28 (S62).

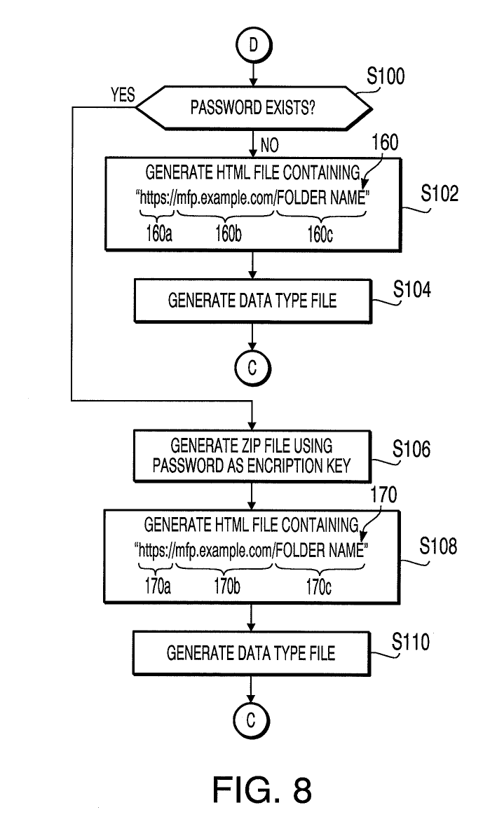

If, for example, the folder generated in S22 of FIG. 5 is the folder 90 shown in FIG. 3, the judgment of the control unit 20 in S80 is “YES.” In this case, the process proceeds to S100 of FIG. 8. In S100, the control unit 20 judges whether the password was generated in S20 of FIG. 5. If the password was not generated (S100: NO), the process proceeds to S102. If the password was generated (S100: YES), the process proceeds to S106.

In S102, the control unit 20 generates the HTML file which contains the URL but not the thumbnail image. An example of the URL 160 generated in S102 is indicated in the flowchart shown in FIG. 8. The URL 160 includes the scheme character string 160a indicating the HTTP communication protocol, the host name 160b of the scanner 10 and the folder name 160c generated in S22 of FIG. 5. The URL 160 generated in S102 does not include the file name or the data type representing character string. The control unit 20 generates the HTML file including the URL 160 as generated above. Then, the control unit 20 stores the HTML file in the storing area 30. After execution of S102, the control unit 20 generates the data type representing file (S104). This step is similar to S58 of FIG. 6. After execution of S104, the process proceeds to S60 of FIG. 6. That is, the control unit 20 transmits the HTML file generated in S102 to the transmission destination designated in S14 of FIG. 5. Further, the control unit 20 updates the contents of the corresponding information storing area 28 (S62).

In S106, the control unit 20 generates ZIP files based on the multiple scan data files generated in S24 of FIG. 5, using the password generated in S20 of FIG. 5 as the encryption key. If one data type was designated in S14 of FIG. 5, and there area two scan data files 94 and 96 (see FIG. 3), the two scan data files 94 and 96 are converted to the ZIP files, respectively. If multiple data types were designated in S14 of FIG. 5, the ZIP files are generated for each of the multiple data types. For example, if four data types were designated in S114 of FIG. 5, and two scan data files 94 and 96 are generated as shown in FIG. 3, eight ZIP files are generated. The file name of each of the ZIP files includes a character string (e.g., “.tiff.zip”) indicating that the ZIP file is converted form the file format designated in S14 of FIG. 5. The control unit 20 then stores the ZIP files generated in S106 under the folder generated in S22 of FIG. 5.

Next, the control unit 20 generates the HTML file containing the URL but not the thumbnail image (S108). An example of the URL 170 generated in S108 is indicated in a flowchart shown in FIG. 8. The URL 170 includes the scheme character string 170a indicating the HTTP communication protocol, the host name 170b of the scanner 10 and the folder name 170c generated in S22 of FIG. 5. The control unit 20 then generates the HTML file including the URL 170 generated as above, and stores the HTML file in the storing area 30. After execution of S108, the control unit 20 generates the data type representing file (S110). The step S110 is similar to the step S57 of FIG. 6. After execution of S110, the process proceeds to S60 of FIG. 6. That is, the control unit 20 transmits the HTML file generated in S108 to the transmission destination designated in S14 of FIG. 5. Further, the control unit 20 updates the contents of the corresponding information storing area 28 (S62).

<Scan Data Providing Process>

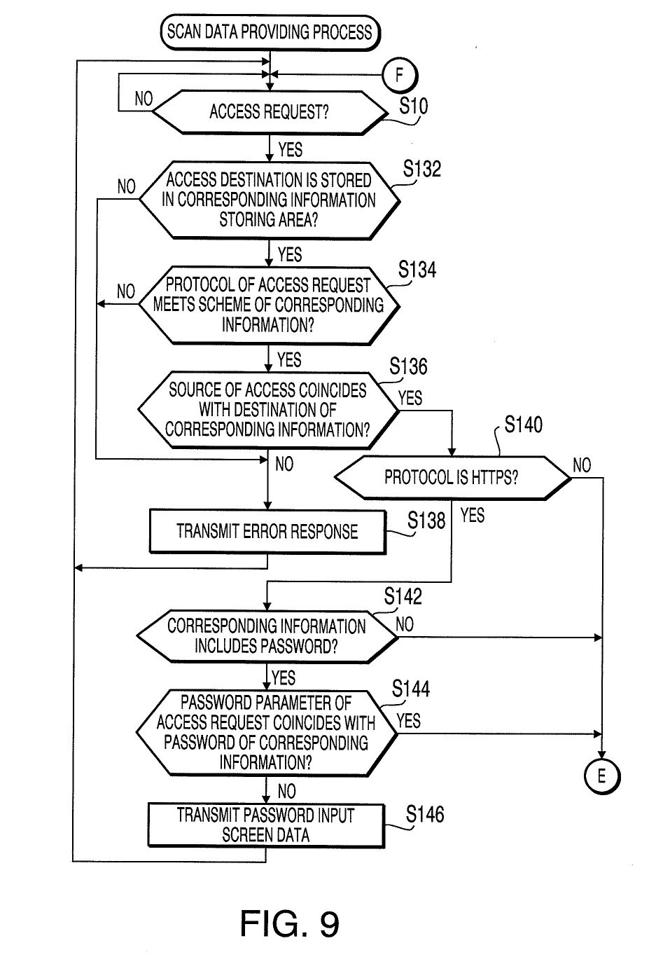

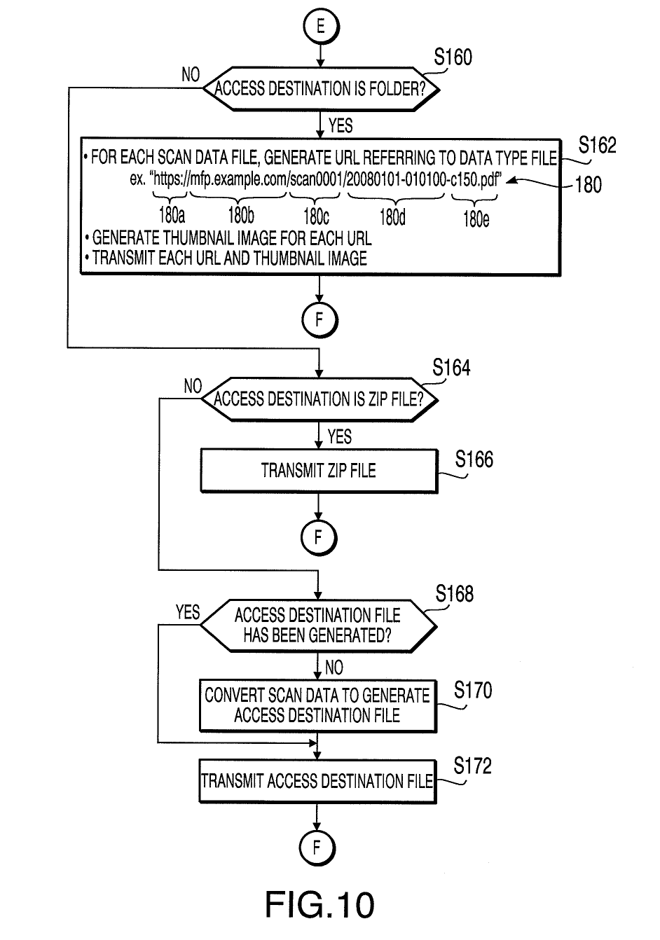

Next, the Scan Data Providing Process of the scanner 10 will be described. FIGS. 9 and 10 show a flowchart of the Scan Data Providing Process of the scanner 10. As described above, in S60 of FIG. 6, the HTML file is transmitted to the transmission destination that is designated in S14 of FIG. 5. In the following description, it is assumed that the HTML file has been transmitted to the shared folder 50 of the PC 40. When the HTML file is transmitted, it is stored in the shared folder 50. Accordingly, the user of the PC 40 can open the HTML file stored in the shared folder 50 by operating the operation unit 50. As the HTML file is opened, the URL's (i.e., the URL's generated in S54, S56, S84, S88, S102 or S108) described in the HTML file are displayed on the display unit 44. Then, the user can designate the URL's by operating the operation unit 42. When one of the URL's is designated by the user, an access request is transmitted from the PC 40 to the scanner 10. The access request includes the URL designated by the user and the IP address “192.168.0.2” (see FIG. 2) of the PC 40. The access request is transmitted using the communication protocol that is identified by the scheme character string (e.g., the character string 120a indicated in S54 of FIG. 6) included in the URL designated by the user. For example, if the URL designated by the user is the URL 120 indicated in S54 of FIG. 6, the access request is transmitted using the HTTPS. For another example, if the URL designated by the user is RUL 140 indicated in S84 of FIG. 7, the access request is transmitted using the HTTP. The control unit 20 of the scanner 10 monitors receipt of the access request transmitted from the PC 40 (S130). When the access request is received (S130: YES), the process proceeds to S132.

The control unit 20 judges whether the URL included in the access request is stored in the corresponding information storing area 28 (S132). If the URL included in the access request is stored in the corresponding information storing area 28 (S132: YES), the process proceeds to S134. In the following description, the information stored in the corresponding information storing area 28 and meets the URL included in the access request will be referred to as identified information. In S134, the control unit 20 judges whether the scheme character string (i.e., http or https) included in the URL 102 of the identified information (see FIG. 4) meets the communication protocol of the access request. If the judgment in S1134 is “YES,” the control unit 20 further judges whether the transmission destination 104 of the identified information (see FIG. 4) and the IP address included in the access request coincide with each other (S136). If the judgment in S136 is “YES,” the process proceeds to S140. If the judgment in S132, S134 or S136 is “NO,” the control unit 20 transmits an error response to the PC 40 (S138).

In S140, the control unit 20 judges whether the communication protocol of the access request is HTTPS. If the communication protocol of the access request is HTTP (S140: NO), the process proceeds to S160. If the communication protocol of the access request is HTTPS (S140: YES), the process proceeds to S142, where the control unit 20 judges whether the identified information includes the password 106 (see FIG. 4). If the password 106 is included in the identified information (S142: YES), the control unit 20 judges whether the password included in the identified information and the password parameter included in the access request coincide with each other (S144). If the password is not described in the password parameter (S144: NO), the control unit 20 transmits password input screen data to the PC 40. The PC 40 displays the password input screen upon receipt of the password input screen data from the control unit 20. Then, the user can input the password by operating the operation unit 42 of the PC 40. When the password is input through the password input screen displayed on the PC 40, the access request including the password, which has been input by the user, is transmitted to the scanner 10. It should be noted that the access request also includes the URL designated by the user and the IP address “192.168.0.2” (see FIG. 2) input by the user are included. As a result of the above process, S144 is executed again after S130-S142 are executed. In S144, if the password included in the identified information and the password included in the access request coincide with each other (S144: YES), the process proceeds to S160 of FIG. 10. When the judgment in S142 is “NO,” the process proceeds to S160.

In S160, the control unit 20 judges whether the URL included in the access request is the URL of a folder or the URL of a file. For example, if the URL 120 which has been generated in S54 of FIG. 6 is designated by the user of the PC 40, the access request includes the URL of the file. In such a case, the judgment in S160 is “NO,” and the process proceeds to S164. If the URL 130 generated in S56 of FIG. 6 is designated by the user of the PC 40, the access request includes the URL 130 of the folder. In this case, the judgment in S160 of FIG. 10 is “YES” and the process proceeds to S162.

In S162, the control unit 20 identifies a group of files which exist as files under the URL (of the folder) included in the access request. For example, if the URL included in the access request is the URL 90 of the folder 90 shown in FIG. 3, the control unit 20 identifies that the data type representing file 92 and the scan data files 94 and 96 as the files of the group. In the following description, the data type representing file identified as the file of the group will be referred to as “identified data type representing file” and the scan data files as identified will be referred to as “identified scan data files.” The control unit 20 generates a URL based on the identified data type representing file and the identified scan data files.

The flowchart of FIG. 10 shows an example of the URL 180 that is generated in S162. the URL 180 includes the scheme character string 180a included in the URL 102 of the identified information (see FIG. 4), the host name 180b included in the URL 102 of the identified information, the folder name 180c included in the URL 102 of the identified information, the file name 180d of the identified scan data file and the data type character string. The data type character string is generated based on the data type described in the document data (e.g., data 92 of FIG. 3) of the identified data type representing file. For example, if multiple combinations of data types are described in the document data of the data type representing file, the URL's corresponding to the number of the combinations are generated for one identified scan data file. For example, if the scan data files 94 and 96 shown in FIG. 3 are the identified scan data files and three combinations of the data types are described in the document data 92d of the data type representing file 92, the control unit 20 generates six URL's. That is, the control unit 20 generates three URL's including the file name 94b (20080101-010200) of the scan data file 94, and three URL's including the file name 96b (20080101-010300) of the scan data file 96. The former three URL's include different data type character strings, and the latter three URL's include different data type character strings. It should be noted that multiple ZIP files are generated and multiple URL's of the ZIP files are generated, respectively, in S106 of FIG. 8. Therefore, if the URL 170, which was generated in S1108 of FIG. 8, is selected by the user of the PC 40, it becomes unnecessary for the control nit 20 to generate the URL, and the URL's of the ZIP files are referred to, respectively. It should be noted that whether the URL included in the access request is the URL 170 of the folder generated in S1108 of FIG. 8 or the URL 130, URL 160 (see S56 of FIG. 6, S102 of FIG. 8) can be judged based on whether the ZIP files generated in S106 of FIG. 8 exist as the files under the URL (i.e., folder) included in the access request.

The control unit 20 generates the thumbnail image for each of the URL's generated as above. The thumbnail images are generated as is done in S54 of FIG. 6. Then, the control unit 20 transmits the thus generated URL's and thumbnail images to the PC 40. The PC 40 displays the received URL's and thumbnail images upon receipt of the same. Then, the user of the PC 40 can select desired one of the URL's by operating the operation unit 42 of the PC 40. When the URL is selected by the user, the access request including the selected URL is transmitted to the scanner 10.

In S164, the control unit 20 judges whether the URL included in the access request is the URL of the ZIP file. This judgment is made by examining whether a character string “.zip” is included in the URL included in the access request. If the URL included in the access request is of the ZIP file (S164: YES), the control unit 20 transmits the ZIP file (i.e., the scan data) corresponding to the URL included in the access request and a command instructing to store the ZIP file in the shared folder 50 to the PC 40. It should be noted that the URL of the shared folder 50 designated by the command is stored in the transmission destination device URL storing area 24 in association with the IP address that is included in the access request. Thus, the control unit 20 can identify the URL of the shared folder 50.

When S166 is executed, the ZIP files are stored in the shared folder 50 of the PC 40. The user can select one of the ZIP files by operating the operation unit 42 of the PC 40. When the ZIP file is selected, a password input screen is displayed so that the user can input the password for opening the ZIP file. Then, by inputting the password, the user can open the ZIP file as selected, thereby the user can obtain the scan data.

For example, when the user selects the URL generated in S54 of FIG. 6 or S84 of FIG. 7, and the URL is included in the access request, the judgment in S164 is “NO” since the URL does not indicate a ZIP file. Further, as mentioned above, a URL which does not include the character string “.zip” in S162. If such a URL is included in the access request, the judgment in S164 also becomes “NO.” When the judgment in S164 is “NO,” the control unit 20 judges whether a file corresponding to the URL included in the access request has been generated (S168). If the judgment in S168 is “NO,” the process proceeds to S170.

In S170, the control unit 20 identifies the data type based on the URL included in the access request. For example, if the URL included in the access request is the URL 180 which is indicated in S162 (i.e., a character string “c150.pdf” is included), the control unit identifies the data type as “color,” “resolution of 150 dpi” and “PDF file.” In such a case, the control unit 20 converts the scan data file 82 (see FIG. 3) that has the folder name 180c and the file name 180 included in the URL 180 into the file having the identified data type, thereby the scan data having the data type selected by the user of the PC 40 is generated (hereinafter, such data will be referred to as converted scan data). Then, the control unit 20 stores the file with which the file name including the file name 180d and the character string 180e of the URL 180 and the converted scan data are associated in the scan data storing area 26 as a file under the folder 80 (see FIG. 3) having the folder name 180c.

The control unit 20 transmits the file corresponding to the URL included in the access request (i.e., the file generated in S170) and a command instructing to store the file in the shared folder 50 to the PC 40 (S172). Then, the file is stored in the shared folder 50 of the PC 40. The user can open the file to obtain the scan data. If multiple transmission destinations are designated in S14 of FIG. 5, when one of the transmission destination accesses the URL, the file corresponding to the URL is generated in S170. Thereafter, when another transmission destination accesses the same URL, the file for the URL has already been generated. In such a case, the judgment in S168 is “YES” and S170 is skipped.

<Cancelling Process>

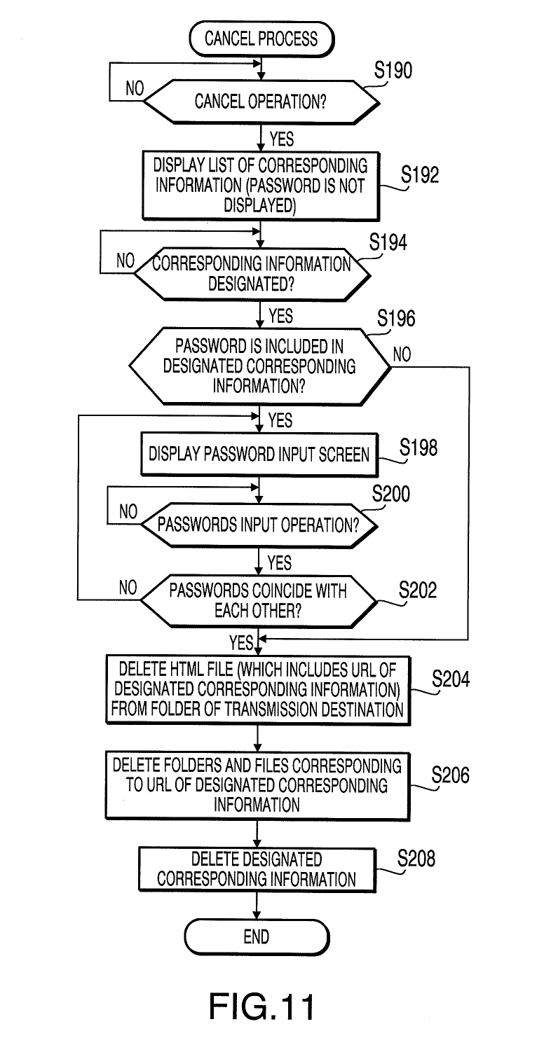

Next, the cancelling process of the scanner 10 will be described. FIG. 11 is a flowchart illustrating the cancelling process of the scanner 10. According to the embodiment, the user can input a command to cancel the scan data by operating the operation unit 12 of the scanner 10. The control unit 20 monitors input of the cancellation command (S190). If the cancellation command is input (S190: YES), the control unit 20 displays a list of the corresponding information 110 and 112 (see FIG. 4) stored in the corresponding information storing area 28 on the display unit 14 (S192). It should be noted that when the list is displayed in S192, the passwords 106 are not displayed.

The user can select one piece of corresponding information from the list displayed on the display unit 14 by operating the operation unit 12. The control unit 20 monitors selection of the corresponding information (S194). When a piece of corresponding information is selected (S194: YES), the control unit 20 judges whether the selected corresponding information includes a password (S196). If the password is not included in the selected corresponding information (S196: NO), the process skips S190-S202. If the password is included in the selected corresponding information (S196: YES), the control unit 20 displays the password input screen on the display unit 14 (S198). Then, the user can input the password by operating the operation unit 12. The control unit 20 monitors input of the password (S200). If the user inputs the password (S200: YES), the control unit 20 judges whether the password of the corresponding information selected in S194 and the password input by the user in S200 coincide with each other (S202). If the passwords do not coincide (S202: NO), the control unit 20 returns to S198 to display the password input screen on the display unit 14 again. If both the passwords coincide with each other (S202: YES), the control unit proceeds to S204.

In S204, the control unit 20 deletes the HTML file including the URL 102 (see FIG. 4) of the corresponding information designated in S194 from the shared folder 50 of the transmission destination 104 (see FIG. 4) of the corresponding information designated in S194. Next, the control unit 20 deletes the folder corresponding to the URL 102 of the corresponding information designated in S194 and all the files under the folder from the scan data storing area 26 (S206). Then, the control unit 20 deletes the corresponding information designated in S194 from the corresponding information storing area 28 (S208) to complete the cancellation process.

As above, the scanner system 2 according to the embodiment of the invention has been described in detail. The scanner 10 transmits the URL's storing the scan data (e.g., 120c of FIG. 6, 130c of FIG. 6, 140c of FIG. 7, 150c of FIG. 7, 160c of FIG. 8 or 170c of FIG. 8) to a device to which the scan data is to be transmitted (e.g., the PC 40). According to the embodiment, as a result of the transmission, the user of the PC 40 can recognize the location of the scan data and access the URL's. When the user of the PC 40 attempts to access the URL, a combination of the URL and the IP address of the PC 40 are transmitted to the scanner 10. The scanner 10 transmits the scan data to the PC 40 on condition that the combination of the URL and the IP address is stored in the corresponding information storing area 28.

There is a possibility that a third person (unauthorized person) secretly looks at the URL. However, according to the embodiment, even if the third person attempts to access the URL using a device other than the PC 40, the scanner 10 does not transmit the scan data since the combination of the URL and the IP address of the device used by the third person has not been stored in the corresponding information storing area 28. Therefore, according to the above-configured embodiment, the possibility that the third person steals the scan data can be well suppressed.

Further, according to the embodiment, when the Scan-To process is executed, a password can be generated. The third person cannot obtain such a password. Therefore, the possibility that the scan data is stolen by the third person can be well suppressed.

The scanner 10 is capable of generating the ZIP file using the password as the encryption key when the HTTP is used as the communication protocol. When the HTTP is used as the communication protocol, the thus generated ZIP file is transmitted. With this configuration, the possibility that the scan data is stolen by the third person can be effectively suppressed. When the HTTPS is used, however, the scanner 10 does not create the ZIP file. It is because, when the HTTPS is used, all the data for communication is encrypted. By omitting the step of generating the ZIP file, the entire process can be executed efficiently.

According the above-described embodiment, the scanner transmits location information indicative of a location of the scan data (location information Y) is transmitted to a device which is identified by device information (location information X). As a result, the user of the device can recognize the location information Y of the scan data. The scanner stores the device information X and the location information Y in an associated manner. The user of a device, which is a transmission destination of the location information Y, can access the location information Y making use of the device. In such a case, a combination of the device information X and the location information Y is transmitted from the device, and received by the scanner. As mentioned above, the combination of the information X and information Y is stored in the device-location storage. Therefore, it is confirmed that the scanner can transmit the scan data which corresponds to the location information Y to the device which corresponds to the device information X.

If a third person steals the location information Y and accesses the location Y from a device (device information thereof is Z) which is different from the device of which the location information is X, the scanner receives a combination of the location information Y and the device information Z. Such a combination, however, is not stored in the device-location storage. Therefore, even if the third person tries to obtain the scan data, it is securely prevented.

There is a possibility that the third person steals the location information Y and tries to access the scan data using the device corresponding to the device information X. To prevent such a problem, the scanner may be provided with an authentication information output unit. It should be noted that the term “output” should be interpreted in the broadest manner and may include “display,” “notify by sound,” “print,” “transmit to another device,” and the like.

The scanner can transmit the scan data using an encryption communication protocol or non-encryption communication protocol.

The term “encryption communication protocol” should be interpreted in the broadest manner, and may include any protocol which employs the encryption communication. Examples of the encryption communication protocol may include HTTPS, FTPS (File Transfer Protocol over SSL/TLS), SFTP (Secure File Transfer Protocol) ant the like. When the encryption communication protocol is used for transmitting the scan data, it may be unnecessary to encrypt the scan data.

The term “non-encryption communication protocol” should also be interpreted in the broadest manner, and may include any protocol which does not use encryption communication. Examples of the non-encryption protocol may include HTTP, FTP (File Transfer Protocol), CIFS (Common Internet File System), SMB (Sever Message Block) and the like.

As described, various types of scan data could be generated. It should be noted that the term “data type” of the scan data should be interpreted in the broadest manner, and may include any item that characterize the data type of the scan data. Example of the items of data type may include the resolution, color information (i.e., color, grayscale, monochromatic, specified number of colors, etc.), the file format (i.e., PDF, TIFF, JPEG, etc.) and combinations thereof.

When multiple data types are designated, multiple pieces of scan data are generated. In such a case, the scanning unit may generate the multiple pieces of scan data based on the multiple data types, respectively. Alternatively, the scanning unit may generate basic scan data which could be converted to generate the multiple pieces of the scan data respectively corresponding to the multiple data types.

For example, when two data types (e.g., color data, and black and white data) are required, the scanning unit may generate only the color scan data since the black-and-white scan data can be obtained by converting the color scan data.

It should be noted that the foregoing is an only an exemplary embodiment and the invention needs not be limited to the above-described configuration, but can be modified in various ways without departing from the scope of the invention. Examples of such modifications will be described below.

(1) The folders and files under the folders stored in the scan data storing area 26 may be deleted when the scan data is transmitted. When multiple transmission destinations are designated in S14 of FIG. 5, the folder(s) and the file(s) under the folder(s) may be deleted when the scan data has been transmitted to all the transmission destinations.

(2) The folders and files under the folders stored in the scan data storing area 26 may be deleted when a predetermined time period has elapsed after generation thereof.

(3) The folders and files under the folders stored in the scan data storing area 26 may be deleted in a chronological order. In such a case, deletion of the data may be executed when the amount of scan data exceeds a predetermined amount.

(4) The folders and files under the folders stored in the scan data storing area 26 may be deleted such that the data transmitted earlier is deleted earlier.

(5) Generation of the URL and thumbnail image for each file, which is executed in S162 of FIG. 10 may be executed when S56 (FIG. 6), S102 (FIG. 8) or S108 (FIG. 8) is executed. Further, in such a case, S162 (FIG. 10) may be omitted.

It should be noted that technical elements described/illustrated in the specification and drawings may have technical usefulness by themselves or various combinations thereof, which are not confined to the combinations of the claims at the time of application. Further, the technique described/illustrated in the specification/drawings may achieve multiple objects, and to achieve at least one of the objects in itself embraces the technical usefulness.

What is claimed is:

1. A scanner, comprising:
a scanning unit configured to scan an object to generate scan data;
a scan data storage configured to store the scan data generated by the scanning unit;
a location information transmitting unit configured to transmit location identifying information indicative of a location where the scan data is stored to an external device;
a device-location storage configured to store device-location information including device identifying information used for identifying a device to which the scan data generated by the scanning unit is transmitted and the location identifying information in a associated manner;
a reception unit configured to receive combination information representing a combination of the device identifying information and the location identifying information;
a scan data transmitting unit configured to transmit the scan data stored at a location identified by the location identifying information to the device identified by the device identifying information on condition that the combination represented by the combination information received by the reception unit is stored in the device-location storage.

2. The scanner according to claim 1, further comprising authentication information output unit configured to output authenticate information,
wherein the device-location storage stores information with which the location identifying information, the authentication information and the device identifying information are associated,
wherein the reception unit is configured to receive the combination information representing the combination of the device identifying information, the location identifying information and the authentication information; and
wherein the scan data transmitting unit transmits the scan data stored at a location that is identified by the location identifying information to the device identified by the device identifying information on condition that the information with which the device identifying information, the location identifying information and the authentication information included in the combination information received by the reception unit are associated is stored in the device-location storage.

3. The scanner according to claim 2, further comprising an encryption unit configured to encrypt the scan data generated by the scan unit using the authentication information output by the authentication information output unit as a key,
wherein the scan data transmitting unit transmits the scan data encrypted by the encryption unit.

4. The scanner according to claim 3, further comprising a judging unit configured to judge whether the scan data can be transmitted using a communication protocol having an encryption function,
wherein, if the judging unit judges that the scan data can be transmitted using the communication protocol having the encryption function, the encryption unit does not encrypt the scan data generated by the scanning unit and the transmitting unit transmits the scan data that is not encrypted, and
wherein, if the judging unit judges that the scan data cannot be transmitted using the communication protocol having the encryption function, the encryption unit encrypts the scan data generated by the scanning unit and the transmitting unit transmits the scan data that is encrypted by the encryption unit.

5. The scanner according to claim 4,
wherein, if the judging unit judges that the scan data can be transmitted using the communication protocol having the encryption function, the location information transmitting unit transmits location identifying information including a scheme character string of an encrypted communication protocol, and
wherein, if the judging unit judges that the scan data cannot be transmitted using the communication protocol having the encryption function, the location identifying information transmitting unit transmits location identifying information including a scheme character string of a non-encrypted communication protocol.

6. The scanner according to claim 1, further comprising a data input unit allowing a user to input data type of the scan data,
wherein the scanning unit generates the scan data in accordance with the data type input through the data input unit, and
wherein the location information transmitting unit further transmits data type information indicative of the data type of the scan data.

7. The scanner according to claim 6, wherein:
when multiple patterns of data type is input through the data input unit, the scanning unit generates multiple pieces of scan data in accordance with the multiple patterns, respectively;
the location information transmitting unit transmits multiple pieces of location identifying information and multiple pieces of data type information respectively corresponding to the multiple pieces of scan data;
the reception unit receives combination information representing a combination of the device identifying information, location identifying information and at least one data type information;
the scan data transmitting unit transmits the scan data on condition that information associated with the device identifying information and the location identifying information included in the combination information received by the reception unit is stored in the device-location storage, the scan data being data identified by the data type information included in the combination.

8. The scanner according to claim 1, wherein, if the scan data generated by the scanning unit includes multiple files, the location information transmitting unit transmits a location of a folder containing the multiple files.

9. The scanner according to claim 1, wherein the location information transmitting unit is configured to transmit the location identifying information and a thumbnail image of the scan data.

10. A computer-accessible recording medium containing computer-executable program including instructions which cause a computer implemented in a scanner to execute the steps of:
scanning an object to generate scan data;
storing the scan data generated in the step of scanning;
transmitting location identifying information indicative of a location where the scan data is stored to an external device;
storing device-location information including device identifying information used for identifying a device to which the scan data generated by the scanning unit is transmitted and the location identifying information in an associated manner;
receiving combination information representing a combination of device identifying information and the location identifying information associated with each other;
transmitting the scan data stored at a location identified by the location identifying information to the device identified by the device identifying information on condition that the combination represented by the combination information received in the step of receiving is stored in the step of storing device-location information.

11. The recording medium according to claim 10,
wherein the instructions further cause the computer to execute the steps of:
encrypting the scan data; and
judging whether the scan data can be transmitted using a communication protocol having an encryption function,
wherein, if the scan data can be transmitted using the communication protocol having the encryption function, the step of encrypting does not encrypt the scan data generated by the scanning unit and the step of transmitting transmits the scan data that is not encrypted, and
wherein, if the scan data cannot be transmitted using the communication protocol having the encryption function, the step of encrypting encrypts the scan data and the step of transmitting transmits the scan data that is encrypted.

12. The recording medium according to claim 10,
wherein the instructions further cause the computer to execute the step of allowing a user to input data type of the scan data,
wherein the step of scanning generates the scan data in accordance with the data type input in the step of inputting, and
wherein the step of transmitting further transmits data type information indicative of the data type of the scan data.
